(19) United States
(12) Patent Application Publication
(10) Pub. No.: US 2014/0336300 A1
(43) Pub. Date: Nov. 13, 2014

(54) HIGH DIMENSIONAL STABILITY POLYESTER COMPOSITIONS

(71) Applicants: Simon Paul Bradshaw, Middlesbrough (GB); Peter John Coleman, Darlington (GB); Stephen Derek Jenkins, Middlesbrough (GB); Sanjay Mehta, Spartanburg, SC (US); Lon J. Mathias, Hattiesburg, MS (US)

(72) Inventors: Simon Paul Bradshaw, Middlesbrough (GB); Peter John Coleman, Darlington (GB); Stephen Derek Jenkins, Middlesbrough (GB); Sanjay Mehta, Spartanburg, SC (US); Lon J. Mathias, Hattiesburg, MS (US)

(73) Assignee: INVISTA NORTH AMERICA S.A R.L., Wilmington (DE)

(21) Appl. No.: 13/810,039

(22) PCT Filed: Jul. 7, 2011
(86) PCT No.: PCT/US11/43165

§ 371 Date: Jul. 30, 2014

Related U.S. Application Data
(60) Provisional application No. 61/363,674, filed on Jul. 13, 2010.

(51) Int. Cl. C08L 67/02; C08J 5/18; C08J 7/12; C08L 67/00

(52) U.S. Cl. CPC C08L 67/02; C08L 67/00; C08J 5/18; C08J 7/123; C08L 2201/08; C08L 2205/02; C08J 2367/02
USPC 522/165; 525/444; 523/100

(57) ABSTRACT

The invention relates to a composition comprising a polyester, a photoreactive comonomer and a co-reactant, wherein the co-reactant comprises at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof. Other aspects of the present invention include articles produced from these compositions and processes for producing these compositions.

### FIELD OF THE INVENTION

The present invention relates to polyester compositions having high dimensional stability at elevated temperatures. In particular it is directed to polyester compositions containing a photoreactive comonomer and a co-reactant, their method of production and their use for articles.

### BACKGROUND OF THE INVENTION

Thermoplastic thermoformed trays for use in conventional and microwave ovens are known in the art. These products typically include polyesters of polyalkylene terephthalates and naphthalates such as polyethylene terephthalate (PET) and polyethylene naphthalate (PEN), particularly in their partially crystallized form. These materials are of particular value as containers for frozen foods requiring good impact strength at freezer temperatures, and more importantly polyester trays must be capable of withstanding rapid heating from freezer temperatures to oven temperatures exceeding 200° C.

However, a common problem with conventional thermoformed polyester trays is that the tray can soften at these oven temperatures, especially since most convection ovens have poor temperature control and for short periods of time the tray may be exposed to temperatures above its melting point. There is also a risk of fire primarily due to the dripping of the polyester onto a heat source, for example an electric heating element or open flame, when the thermoplastic material reaches its melting point.

Conventionally, the prevention of this melting and dripping onto a heat source has been achieved through the use of protective sheets, upon which the tray may rest when placed in a conventional oven. However, the consumer may forget to place their frozen food or ready-to cook products on the protective sheets. In commercial operations for pre-cooked foods the additional use of protective trays adds an additional cost, due to cleaning, to their process.

It is known in the field of engineering plastics to use fillers in order to improve the physical properties of molded parts. Fillers increase the tensile strength, stiffness, impact resistance, toughness, heat resistance and reduce creep and mold shrinkage. Fillers are typically used at loadings of 20 to 60% by weight of the plastic. Typical fillers are glass fibers, carbon/graphite fibers, ground micas, talc, clays, calcium carbonate and other inorganic compounds such as metallic oxides. However fillers cannot prevent the polyester softening and melting if an oven temperature is close to the polyester melting point.

Another approach to improving the dimensional stability of polyester to exposure to high temperatures for a short time is the incorporation of a photoreactive comonomer into the polyester, followed by irradiation. U.S. Pat. No. 3,518,175 discloses the use of 4,4′-benzophenone dicarboxylic acid (or its ester) as the photoreactive comonomer. UV irradiation of the oriented film was conducted under conditions in which the film was no longer soluble in a solvent. JP 61-057851 B4 discloses an article obtained by irradiating a polyester resin containing aliphatic unsaturated groups, for example an allyl group and a photoreactive comonomer.

### SUMMARY OF THE INVENTION

There still remains a need for a composition having sufficient thermal stability for use as trays for cooking food without distorting or melting in conventional ovens.

In accordance with the disclosed invention, a polyester composition has been found having sufficient thermal stability for use as trays in conventional ovens. In one aspect, a composition is disclosed comprising a polyester, a photoreactive comonomer and a co-reactant, wherein said co-reactant comprises at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof.

In another aspect, articles produced from these compositions and processes for producing these compositions are disclosed. The articles can be UV cured to provide high thermal dimensional stability. The process comprises a) copolymerizing i) an alkane diol or cycloalkane diol, ii) an aliphatic dicarboxylic acid, a cycloaliphatic dicarboxylic acid or an aromatic dicarboxylic acid, iii) a photoreactive comonomer comprising at least one member selected from the group consisting of a diol of benzophenone, a dicarboxylic acid of benzophenone, a dicarboxylic ester of benzophenone, an anhydride of benzophenone and mixtures thereof, and iv) a co-reactant comprising at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof to form a polyester; b) optionally compounding at least one member selected from the group consisting of a filler, an additive and mixtures thereof with said copolymerized polyester; c) molding said article from said polyester and d) UV curing the molded article. Further, articles having a Failure Temperature of about 280° C. or greater are also disclosed.

### DETAILED DESCRIPTION OF THE INVENTION

Disclosed are compositions comprising a polyester, photoreactive comonomer and co-reactant, wherein said co-reactant comprises at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof.

The photoreactive comonomer can be a benzophenone derivative, for example the photoreactive comonomer can be at least one member selected from the group consisting of a diol of benzophenone, a dicarboxylic acid of benzophenone, a dicarboxylic ester of benzophenone, an anhydride of benzophenone and mixtures thereof. The photoreactive comonomer can be incorporated into the polyester as main chain or as pendant moieties, or bound to the ends of the polyester chains. The photoreactive comonomer can be 4,4′-, 3,5- or 2,4-benzophenone dicarboxylic acids, or their ester equivalents, or 4,4′-, 3,5- or 2,4-benzophenone diols. A suitable photoreactive comonomer is 4,4′-dihydroxy benzophenone. The weight percent of the photoreactive comonomer in the polyester can be in the range of about 0.1 to about 10 weight %, or in the range of about 0.5 to about 5 weight %. Below about 0.1 weight % of the photoreactive comonomer there is insufficient photoinitiator to maintain the cross-linking reaction when the article is irradiated with UV radiation. The photoreactive comonomer can be added during the transesterification or esterification step of the polyester polymerization process.

The co-reactant can be an unsaturated aliphatic or aromatic diacid or ester equivalent such as an unsaturated dicarboxylic acid or an unsaturated dicarboxylic or fatty acid ester. Suitable co-reactants can be octadecenedioic acid, tetrahydrophthalic anhydride and maleic anhydride, for example the co-reactants can be maleic anhydride or tetrahydrophthalic anhydride. The weight percent of co-reactant in the polyester can be in the range of about 0.1 to about 10, or in the range of about 0.5 to about 5 weight %. The co-reactant can be added during the transesterification or esterification step of the polyester polymerization process.

Generally polyesters can be prepared by one of two processes, namely: (1) the ester process and (2) the acid process. The ester process is where a dicarboxylic ester (such as dimethyl terephthalate) is reacted with ethylene glycol or other diol in an ester interchange reaction. Because the reaction is reversible, it is generally necessary to remove the alcohol (methanol when dimethyl terephthalate is employed) to completely convert the raw materials into monomers. Certain catalysts are known for use in the ester interchange reaction. In the past, catalytic activity was then sequestered by introducing a phosphorus compound, for example polyphosphoric acid, at the end of the ester interchange reaction. Then the monomer undergoes polycondensation and the catalyst employed in this reaction is generally an antimony, titanium or aluminum compound or other well known polycondensation catalyst.

In the second method for making polyester, an acid (such as terephthalic acid) is reacted with a diol (such as ethylene glycol) by a direct esterification reaction producing monomer and water. This reaction is also reversible like the ester process and thus to drive the reaction to completion one must remove the water. The direct esterification step does not require a catalyst. The monomer then undergoes polycondensation to form polyester just as in the ester process, and the catalyst and conditions employed are generally the same as those for the ester process.

For most container, sheet and thermoformed tray applications this melt phase polyester is commonly further polymerized to a higher molecular weight by a solid state polymerization. High molecular weight resins produced directly in the melt phase are currently being commercialized. The scope of the current invention also covers this non-solid state polymerized resin.

In summary, in the ester process there are two steps, namely: (1) an ester interchange, and (2) polycondensation. In the acid process there are also two steps, namely: (1) direct esterification, and (2) polycondensation.

Suitable polyesters can be produced from the reaction of a diacid or diester component comprising at least 65 mole % of an aromatic dicarboxylic acid or C₁-C₄ diallyl ester of an aromatic dicarboxylic acid, for example at least 65 mole % to at least 95 mole % or at least 95 mole %, and a diol component comprising at least 65 mole % ethylene glycol, for example at least 65 mole % to at least 95 mole % or at least 95 mole %. The aromatic diacid component can be terephthalic acid and the diol component can be ethylene glycol, thereby forming polyethylene terephthalate (PET). The mole percent for the entire diacid components total 100 mole %, and the mole percentage for the entire diol components total 100 mole %.

Where the polyester components are modified by one or more diol components other than ethylene glycol, suitable diol components of the described polyester can be selected from 1,4-cyclohexandedimethanol, 1,2-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, or diols containing one or more oxygen atoms in the chain, for example diethylene glycol, triethylene glycol, dipropylene glycol, tripropylene glycol or mixtures of these, and the like. In general, these diols contain 2 to 18, for example 2 to 8 carbon atoms. Cycloaliphatic diols can be employed in their cis or trans configuration or as mixture of both forms. Modifying diol components can be 1,4-cyclohexanedimethanol or diethylene glycol, or a mixture of these.

Where the polyester components are modified by one or more acid components other than terephthalic acid, the suitable acid components (aliphatic, alicyclic, or aromatic dicarboxylic acids) of the linear polyester can be selected from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, or mixtures of these and the like. In the polymer preparation, a functional acid derivative thereof can be used such as the dimethyl, diethyl, or dipropyl ester of the dicarboxylic acid. The anhydrides or acid halides of these acids also can be employed where practical.

In addition to polyester made from terephthalic acid (or dimethyl terephthalate) and ethylene glycol, or a modified polyester as stated above, the present invention also includes the use of 100% of an aromatic diacid such as 2,6-naphthalene dicarboxylic acid or bibenzoic acid, or their diesters, and a copolyester made by reacting at least 85 mole % of these aromatic diacids/diesters with any of the above dicarboxylic acid/ester comonomers.

In addition to polyester made from ethylene glycol and terephthalic acid, or a modified polyester as stated above, the present invention includes the use of 100% of diols such as 1,3-propane diol, 1,4-butane diol or 1,4-cyclohexanedimethanol and a copolyester made by reacting at least 85 mole % of these diols with any of the above dicarboxylic acid/ester comonomers.

The polyester of the present invention can be random or block copolymers of these homopolyesters or copolyesters; or blends of these homopolyesters or copolyesters. For example, the polyester can be selected from polyethylene terephthalate, polyethylene naphthalate, polyethylene isophthalate, polybutylene terephthalate, copolymers of polyethylene terephthalate, copolymers of polyethylene naphthalate, copolymers of polyethylene isophthalate, copolymers of polybutylene terephthalate, and mixtures thereof. Suitable polyester can be a copolymer of polyethylene terephthalate. Aliphatic polyester such as polylactic acid, polyglycolic acid polyhydroxy alkonoates are also contemplated by the present invention.

Upon completion of the production of the polyester resin by melt polycondensation, it can be subjected to a solid state polymerization process to increase the molecular weight (Intrinsic Viscosity (IV)) for use in the production of thermoformed articles. This process usually consists of a crystallization step in which the resin is heated to about 180° C., in one or more stages, followed by heating at 200° C. to 220° C. with a stream of heated nitrogen to remove the by-products of the solid-state polymerization as well as by-products of the melt polymerization such as acetaldehyde in the case of PET. Other methods of increasing the molecular weight are also within the scope of the present invention, such as by maintaining the resin in the melt polycondensation stage until the required intrinsic viscosity increase has been achieved by employing certain reactors. In this case the subsequent steps after the last melt reactor may comprise one or all of the following steps, a possible addition of at least one additive, formation of solid particles, crystallization of these particles and drying to remove moisture if present. The IV of the polyester resin can be in the range of about 0.6 to about 1.2 dl/g, or in the range of 0.7 to 1.0 dl/g. If the IV of the polyester is less than about 0.6 dl/g the composition will have a low gel content after UV irradiation.

Fillers can include glass fiber, carbon fiber, aramid fiber, potassium titanate fibers and fiber shaped. Sheet shaped fillers can be, for example, clays, mica, talc or graphite. Examples of particle shaped fillers can be glass spheres, quartz powder, kaolin, boron nitride, calcium carbonate, barium sulfate, silicate, silicon nitride, titanium dioxide, and oxides or hydrated oxides of magnesium or aluminum. Other fillers that can be used in the composition are nanoparticles such as silica and titanium dioxide. The nanoparticles and clays can be surface treated with surfactants, and in the case of sheet shaped fillers they can be exfoliated into their primary sheets. Mixtures of these fillers can be used. The composition can contain up to 50% by weight, for example from about 0.1 to about 50% by weight or from about 0.5 to about 25% by weight of fiber, sheet or particle shaped filler or reinforcing agent or mixtures of such materials. Fillers can be glass fibers and fillers based on nanosilica and surface treated nanosilica or mixtures thereof.

Additives can be incorporated into the composition during polymerization or formation of the article. Additives can include dye, pigment, filler, branching agent, anti-blocking agent, antioxidant, anti-static agent, biocide, blowing agent, coupling agent, flame retardant, heat stabilizer, impact modifier, ultraviolet light stabilizer, visible light stabilizer, crystallization aid, lubricant, plasticizer, processing aid, acetaldehyde, oxygen scavenger, barrier polymer, slip agent, and mixtures thereof. The impact modifier can be an ethylene acrylic copolymer or an ethylene acrylic methacrylic terpolymer. Additionally, typical additive packages for thermoformable trays are disclosed in U.S. Pat. No. 5,409,967 and U.S. Pat. No. 6,576,309, which are hereby incorporated by reference in their entirety.

Also disclosed are articles made from the polyester composition. The article can be a film, a sheet, a thermoformed tray, a blow molded container and a fiber. The articles can also be manufactured with multiple layers, one of which is the polymer composition of the invention, by lamination of the sheets or co-extrusion of the sheet.

Food containers such as trays are generally manufactured by a thermoforming process, although injection and compression molding can be used. In the thermoforming process the polyester composition is melted and mixed in an extruder and the molten polymer is extruded into a sheet and cooled on a roller. Thermoforming, also called vacuum forming, is the heating of a thermoplastic sheet until it is pliable and stretchable, and then forcing the hot sheet against the contours of a mold by using mechanical force and vacuum. When held to the shape of the mold by atmospheric pressure and allowed to cool, the plastic sheet retains the mold's shape and detail. Improved heat resistance can be achieved by annealing the article in the mold at temperatures greater than 100° C., and for example greater than 130° C.

The UV irradiation of the article may be carried out by conventional procedures. As the light source, there may be employed a high pressure mercury lamp, a low pressure mercury lamp, a xenon lamp, etc. In general, the ultraviolet rays having a wavelength of 200 to 600 nm, for example a wavelength of 350 to 400 nm (UV A band) corresponding to the maximum absorbance of the photoreactive comonomer and maximum transmission of the UV irradiation through polyester can be used. Glass filters are used to filter out radiation with wavelengths less than 325 mu to minimize the degradation of the polyester. The conditions of irradiation such as irradiation time are dependent on the intensity of the light source, the thickness of the article and the degree of cross-linking required for the high temperature dimensional stability of the article. The irradiation can be performed at a temperature higher than the glass transition temperature, and lower than the melting point, of the shaped article before irradiation for example greater than about 75° C. Usually, the irradiation time may be from 1 second to 30 minutes depending on the physical or chemical properties as desired. The dose (energy density arriving at the surface of the sample, J·cm⁻²) can be measured with a radiometer. The dose can be in the range of about 10 to about 500 J·cm⁻², or in the range of about 100 to 400 J·cm⁻². The design and layout of the UV lamps will be determined by the required dose and the shape of the article. UV irradiation is “line-of-sight” and care must be taken to ensure all parts of the article are irradiated to the degree required for the specific application, and that no sections are in the shadow of the UV light. Thermoformed articles that exit the mold at temperatures above the glass transition temperature of the polymer composition, can be continuously fed to a bank of UV lamps to minimize the need to reheat the parts.

Further disclosed is a method for producing a polyester article comprising a) copolymerizing i) an alkane diol or cycloalkane diol, ii) an aliphatic dicarboxylic acid, a cycloaliphatic dicarboxylic acid or an aromatic dicarboxylic acid, iii) a photoreactive comonomer comprising at least one member selected from the group consisting of a diol of benzophenone, a dicarboxylic acid of benzophenone, a dicarboxylic ester of benzophenone, an anhydride of benzophenone and mixtures thereof, and iv) a co-reactant comprising at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof to form a polyester; b) optionally compounding at least one member selected from the group consisting of a filler, an additive and mixtures thereof with said copolymerized polyester; c) molding said article from said polyester and d) UV curing the molded article. The molding of step (c) and curing of step (d) can be integrated into a continuous process. The UV curing of step (d) can use UV-A radiation and a 325 nm cut-off filter. The UV-A radiation can be about 10 to about 500 J·cm⁻².

In another aspect, an article having a Failure Temperature of about 280° C. or greater is disclosed.

### EXPERIMENTAL

### 1. Photoreactive Comonomer and Co-Reactant

The amount of the photoreactive comonomer and co-reactant in the polyester was determined through proton NMR spectra using a Varian spectrophotometer operating at 300 MHz. The ratio of the areas of the aromatic peaks associated with the photoreactive commoner to that of the terephthalic acid was used to determine the weight % of photoreactive commoner in the polymer. Similarly the peak area associated with the double bond of the co-reactant compared to the area of the aromatic peak of the terephthalic acid was used to determine the weight % of the co-reactant in the polymer.

### 2. Intrinsic Viscosity (IV)

Intrinsic viscosity (IV) is determined using an Anton Parr SVM 3000 Stabinger Viscometer (SVM 3000) which is a rotational viscometer based on a modified Couette principle with a rapidly rotating outer tube and an inner measuring bob which rotates more slowly, producing a viscosity value, η, for the solution. 0.25 grams, 0.5 grams and 0.75 grams of the polymer are each dissolved in 50 mm of orthochlorophenol (OCP) at a temperature of 100° C. for 30 minutes to produce solutions of 0.5 weight %, 1.0 weight % and 1.5 weight %. The solutions are cooled to 25° C., placed in sample tubes and then placed in an auto sampler and evaluated, together with a sample tube containing pure OCP. The viscosity, η, is thus determined for each solution and also for the pure OCP, η₀. From these values, the reduced viscosity of each solution, η_{red}, can be determined using equation:

η_{red}=(η/η₀)−1)/c

where c is the concentration of the solution.

The intrinsic viscosity of the polymer is determined by plotting reduced viscosity against concentration and extrapolating the plot to zero concentration.

### 3. Gel Content

The gel content (wt.-%) of the polymer was determined by stirring the irradiated samples (5 wt.-%) in trifluoroacetic acid (TFA) at room temperature for 24 hours. The insoluble gel fractions were separated by filtration using Whatman filter paper No 2 (42.5 mm Diameter) and dried above 100° C. to constant weight under vacuum. The gel content was calculated using following formula:

% gel=[Wg/Wi]×100

Wg=Weight of insoluble gel after filtration

Wi=Initial weight of Polymer

### 4. UV Irradiation

The initial laboratory UV irradiation of the samples was conducted by using Fusion Hammer 6 UV curing line (Fusion UV Systems, Inc., Gaithersburg Md., USA) using a D bulb (unless otherwise stated) at a line speed of 6 cm·sec⁻¹. PET samples were laid on a steel panel and covered by a 325 nm cut off filter, then heated up to 100° C. (measured by Infrared Type K Thermometer, Fisher Scientific Co.) on a hot plate. Each pass of the PET samples gave a dose of 2.5 J·cm⁻² UV-A exposure. Normally, 12 and 24 passes were performed in order to obtain 30 and 60 J·cm⁻² UV exposure, respectively. In some cases, 12 passes for both sides of PET samples were performed in order to get better UV penetration. In other cases the line speed was reduced such that the required UV exposure could be achieved in one pass.

Large scale trials were conducted on a Fusion VPS/I600 UV line with two 240 w/cm D bulbs. The lamps were positioned side-by-side arrangement for sheet samples giving a dose of about 19 J·cm⁻² for each pass under the lamps. The lamps for the tray samples were arranged with one parallel and the other perpendicular to the belt. The distance of the lamps from the tray surfaces was varied, but typically the dose was 20 J·cm² for each pass under the lamps.

### 5. High Temperature Thermal Stability

### a) Oven Test

As a screening test, samples of the sheet or thermoformed tray were cut into test specimens of 6 cm in length and 1 cm. in width, the thickness being in the range of 315 μm to 700 μm. These test specimens were clamped on a frame leaving a horizontal cantilevered length of 4 cm. The frame was placed in a hot oven at a temperature of 260° C., and the test specimens observed through a glass door. If the test specimen had shrunk, melted or bent more than 45° from horizontal after a time period of 15 min. it was rated as a failure, similar ratings were given after 30 min. for those test specimens that had past the test after 15 min.

### b) Deformation Test

In another screening test, samples of the sheet or thermoformed tray were cut into small sections weighing about 10 mg. These sections used placed in a DSC pan and the instrument used to heat the sample, at 20° C./min, to 320° C. and held at this temperature for 5 min. The sample was then cooled to room temperature and the shape visually assessed. If the section retained its original shape, i.e. had not melt or flowed at 320° C., this indicated the section was a cross-linked network.

### c) Failure Temperature

Quantitative high temperature stability data were measured using a TA Instruments DMA instrument in a controlled force mode, following the principles of the ASTM Standard D 648, using a three-point bending configuration. The three-point clamp used has a total span of 10 mm. The sheet, or thermoformed tray, was cut into about 15 mm long and 15±0.1 mm wide samples and the thickness measured. A force equivalent to a sample stress of 455 kPa was applied the sample. The sample was heated at 50° C./min. to 300° C. and the sample deflection was continuously recorded. The temperature at which a deflection of 5 mm occurred was recorded as the Failure Temperature.

### 6. Dynamic Mechanical Analysis

The tan δ of films was measured using a TA Instruments Dynamic Mechanical analyzer at a frequency of 10 cycles/sec, a strain of 0.1% and a heating rate of 2° C./min. The temperature of the tan 8 peak was recorded.

### 7. Preparation of the Polyester Resin

Unless stated to the contrary, the following general procedure was used to prepare polyesters containing the photoreactive comonomer and co-reactant.

Monomer was produced in a stirred batch reactor by heating a slurry of terephthalic acid, ethylene glycol, the photoreactive comonomer, co-reactant and sodium hydroxide (50 ppm based on the weight of polymer), to 250° C. at a pressure of about 5 bar, under reflux, until the theoretical amount of water was removed. After this esterification stage the pressure was reduced to atmospheric, and phosphoric acid, antimony trioxide catalyst and cobalt acetate colorant (if required) was added. The target retained antimony was 250 ppm Sb and target phosphorus was 20 ppm P, based on polymer. The temperature was raised to obtain a batch polymer temperature of 295° C., and the pressure reduced to less than about 3 mbar. When the torque required to stir the reaction mixture, which is proportional to the polymer molecular weight, reached to desired value, the stirrer is stopped, the vacuum released and the reactor pressurized with nitrogen to about 2 bar. The molten polymer is extruded into a water bath, quench and pelletized.

Solid state polymerization was conducted using a static bed reactor with a current of heated nitrogen. The amorphous pellets were first crystallized for 1½ hours at 150° C. and then solid state polymerized at between 205 and 215° C. for between 12 and 18 hours.

### 8. Thermoforming Process

The polymer was dried at 175° C. for a minimum of five hours in a standard convection air oven. A known weight of polymer is then put into nitrogen purged metal drum and sealed. The drum was opened and, if an impact modifier was required it was added to the drum and the lid resealed loosely whilst the drum was rolled and turned to mix the contents (approx 30 seconds), and the polymeric composition was the transferred to the extruder hopper.

The extruder used to prepare sheets was a Davis Standard BC 50 mm single screw extruder (3:1 compression ratio on screw) with an EDI 500 mm wide sheet die (Davis-Standard LLC, Pawcatuck, Conn., USA). The extruder had a breaker plate with a 40 and 60 mesh attached and a standard Davis Roll stack. The polymer was extruded through a die on to the stack rollers before being pulled through a further roller where the sheet was cut (about 46.5 cm×40 cm and about 700 microns thick).

The thermoforming equipment was a Formech FP1 thermoformer (Formtech International Ltd., Harpenden, England). The female tray mold (18.5 cm long×14.5 cm wide×4.3 cm deep, divided in the middle into two sections 12 mm apart) was clamped to a base plate. The sheet was clamped in position and the heater box was moved over the sheet and left for a period of time. The heaters were then removed and the table lifted approx 1-2 mm to touch the sheet before the vacuum is applied. Once the sheet has formed into the shape of a tray, cold air is blown over for approx 20 seconds before the sheet is unclamped.

### 9. Compounding Process

The equipment used to compound fillers was a Prism 24 mm MC modular twin screw extruder (Thermo Fisher Scientific, Inc., Waltham Mass., USA) 28:1 LID with two mixing regions to fully compound the filler into the polymer matrix. The filler was added using a volumetric feeder through a side feed point at the 8:1 region of the barrel just ahead of the first mixing region. A sheet was produced via a 0.3-5 mm sheet die and casting rollers which were gapped to produce a smooth surface finish. The temperature profile of the extruder was over 6 zones plus a die and ranged from 270° C. at the feed pocket to 285° C. at the die.

### 10. Materials

The following additives were used in the Examples.

i) Photoreactive Comonomer

4,4′-dihydroxy benzophenone (Eurolabs, Stockport, United Kingdom)

ii) Co-Reactant

Maleic Anhydride (Aldrich, Gillingham, United Kingdom)

Tetrahydrophthalic anhydride (Aldrich, Gillingham, United Kingdom)

iii) Glass Fibers

HP 3780 4.5 mm×1.3 μm dia. chopped strand

HP 3786 4.5 mm×1 μm dia. chopped strand
(PPG Ind., Pittsburgh Pa., USA)

iv) Nanosilica Particles

Degussa Aerosil®200

Preparation of 3-aminopropyltrimethoxy silane (APS) Treated Nanosilica

100 g of silica nanoparticles (Degussa Aerosil®200, particle size of 12 nm) were dispersed in 900 g of ethylene glycol and milled for 8 passes (pump speed was set at 3000 rpm and residence time was 4 minutes per pass) using a Dynomill Multilab (chamber size 600 ml, yttrium stabilized beads sized 0.5-0.7 mm) The dispersion was heated to 120° C. and 7.5 g of 3-aminopropyltrimethoxy silane (APS) (Gelest, Inc) was added instantaneously. The mixture was refluxed for 18 h. This compound comprised 1.0 mmol g⁻¹ of the amino siloxane derivative, corresponding to 1.2 mmol of NH₂ groups/g silica.

### EXAMPLES

### Example 1

A series of polymers on a 5 kg scale batch reactor were prepared with 4 wt. % 4,4 dihydroxybenzophenone (DHBP) and varying amount of maleic anhydride (MA) to a target IV of 0.58. The mole ratio of ethylene glycol (EG) to terephthalic acid (PTA) was 1.2. The results are set forth in table 1.

TABLE 1

| Run | Maleic Anhydride, wt. % | Achieved target IV |
|---|---|---|
| 1 | 0 | Yes |
| 2 | 0.25 | Yes |
| 3 | 0.5 | Yes |

Another series of polymers were prepared using a 70 kg batch reactor with 4 wt. % DHBP, with and without maleic anhydride. This reactor uses a Maag gear pump after the esterification stage and the polymer is cast under a reduced vacuum of between 1 mm and 30 mm of mercury. The mole ratio of ethylene glycol (EG) to terephthalic acid (PTA) was varied and the ability to polymerize to the target IV of 0.62 was noted. The results are set forth in Table 2.

TABLE 2

| | Maleic Anhydride, | | |
|---|---|---|---|
| Run | wt. % | EG/PTA mole ratio | Achieved target IV |
| 4 | 0 | 1.2 | No |
| 5 | 0 | 1.28 | No |
| 6 | 0 | 1.55 | Yes |
| 7 | 0.5 | 1.55 | Yes |

Polymer chip from the 5 kg and 70 kg batch reactor was analyzed, using a proton NMR Varian spectrophotometer operating at 300 MHz, to determine the amount of DHBP that had reacted with the ethylene glycol or terephthalic acid (as a wt. % of PTA). The results are set forth in Table 3.

TABLE 3

| Run | DHBP reacted with EG, % | DHBP reacted with PTA, % |
|---|---|---|
| 1 | 79.0 | 14.5 |
| 4 | 60.8 | 37.3 |
| 5 | 56.7 | 40.2 |
| 6 | 83.3 | 13.3 |
| 7 | 74.1 | 22.2 |

The data demonstrates that to reach the target IV in a direct esterification polymerization using PTA, a high proportion, greater than 61 wt. %, of the DHBP, reacts with the ethylene glycol forming an ether linkage.

A copolymer was prepared using dimethyl terephthalate and ethylene glycol at a 2.1 mole ratio. The DHBP (4.1 wt. %) was added during the ester interchange reaction catalyzed by 70 ppm Mn (from manganese acetate). The ester interchange catalyst was sequestered with polyphosphoric acid (45 ppm P). Tetrahydrophthalic anhydride (THPA) (8 wt. %) was added and the polycondensation, catalyzed by antimony trioxide (300 ppm Sb), was conducted at 285° C. to an IV of 0.65 dl/g (all weight % and ppm based on the copolymer). NMR analysis showed that all the DHBP had been incorporated into the copolymer.

### Example 2

A series of compositions using a 70 kg batch reactor, some with 4 wt.-% DHBP as the photoreactive comonomer, others with maleic anhydride (MA) as the co-reactant and combinations of DHBP and MA were prepared using a EG/PTA mole ratio of 1.28 or 1.55. Solid state polymerization was conducted using a fluidized bed reactor with a counter current of heated nitrogen. The amorphous pellets were first crystallized for 13 hours at 85° C. and then solid state polymerized at 210° C. for about 5 hours. The resin was compounded with 12 wt. % Lotryl® MA resin and formed into sheets. These 700μ sheets were heated to 100° C., irradiated using the Fusion Hammer 6 UV line with an H bulb and a dose of 60 J·cm⁻². The details of the compositions and are set forth in table 4.

TABLE 4

| | Photoreactive | |
|---|---|---|
| EG/PTA | comonomer | Co-reactant |

| Run | mole ratio | DHBP wt. % | Type | wt. % | IV |
|---|---|---|---|---|---|
| 8 | 1.28 | 0 | None | 0 | 0.67 |
| 9 | 1.28 | 0 | MA | 0.5 | 0.72 |
| 10 | 1.55 | 4 | None | 0 | 0.68 |
| 11 | 1.55 | 4 | MA | 0.5 | 0.68 |

The gel content of these sheets was measured and the results set forth in Table 5. The gel content correlates to the degree of cross-linking after irradiation.

TABLE 5

| Run | Sheet IV | Gel content, % |
|---|---|---|
| 8 | 0.798 | 5-10% |
| 9 | 0.757 | 10-15% |
| 10 | 0.749 | 22 |
| 11 | 0.739 | 75 |

The data demonstrates that both the photoreactive comonomer (DHBP) and co-reactant are required to obtain a high degree of cross-linking after irradiation.

### Example 3

A series of compositions using a 5 kg batch reactor, with 4 wt.-% DHBP as the photoreactive comonomer, with maleic anhydride or tetrahydrophthalic anhydride (THPA) as the co-reactant, were prepared using a EG/PTA mole ratio of 1.2. Solid state polymerization was conducted using a static bed reactor with a flow of heated nitrogen to a target IV of 0.82.

These polymer compositions were compounded, with and without glass fibers, into sheets using a Prism 24 mm MC modular twin screw extruder. A commercial grade polymer was also included as a control. The IV of the sheets after compounding was about 0.75. These sheets were heated to 100° C., irradiated using the Fusion Hammer 6 UV line with an H bulb with a dose of 60 J·cm⁻². The high temperature thermal stability of these sheets was measured by the Oven Test method and the results set forth in table 6.

TABLE 6

| | | | | | Thermal Stability, | |
|---|---|---|---|---|---|---|
| | Co-reactant | | Glass Fiber | | 260° C. oven | |
| Run | Type | Wt. % | Type | Wt. % | 15 min. | 30 min. |
| Commercial | None | 0 | HP3780 | 15 | Failed | Failed |
| Resin | | | | | | |
| 12 | THPA | 0.5 | None | 0 | Failed | Failed |
| 13 | THPA | 0.5 | HP3780 | 15 | Passed | Passed |
| 14 | THPA | 2 | None | 0 | Failed | Failed |
| 15 | THPA | 2 | HP3786 | 10 | Pass | Failed |
| 16 | MA | 0.5 | None | 0 | Failed | Failed |
| 17 | MA | 0.5 | HP3780 | 10 | Pass | Failed |

The data demonstrates that the only the addition of glass fiber shows improvements in thermal stability of irradiated sheets prepared with compositions comprising 4 wt. % photoreactive comonomer and 0.5 to 2 wt. % co-reactant.

### Example 4

A series of copolyesters were prepared according to the method of Example 2 containing 4 wt. % DHBP and 8 wt. % THPA. In addition to HP 3786 glass fibers, nanosilica (SiO₂) was compounded into the sheets. The sheets were heated to 100° C., irradiated using the Fusion Hammer 6 UV line with an H bulb at a dose level of 100 J·cm⁻². The initial polymer IV and that of the compounded sheet was measured (adjusting for the filler content). The gel content after irradiation was measured and the irradiated samples tested by the Deformation Test. If the sheet maintained its original shape it was recorded as a ‘Pass’ and if it had melted or deformed to a significant extent it was recorded as a ‘Fail’. The results are set forth in Table 7, all weights expresses as a % of the copolyester.

TABLE 7

| | | | | | | | | Defor- |
|---|---|---|---|---|---|---|---|---|
| | DHBP | THPA | Glass | SiO₂ | Poly- | Sheet | % | mation |
| Run | wt. % | wt. % | wt. % | wt. % | mer IV | IV | Gel | Test |
| 18 | — | — | — | — | 0.89 | 0.75 | 0 | Fail |
| 19 | — | — | 15 | — | 0.89 | 0.78 | 0 | Fail |
| 20 | 4 | 8 | — | 2 | 0.96 | 0.81 | 98 | Fail |
| 21 | 4 | 8 | 15 | 2 | 0.96 | 0.81 | 98 | Pass |
| 22 | 4 | 8 | — | 2 | 0.82 | 0.75 | 100 | Fail |
| 23 | 4 | 8 | 15 | 2 | 0.82 | 0.72 | 93 | Pass |

A gel content of greater than 90% is a necessary but not always indicative of passing the Deformation Test.

### Example 5

A series of copolyesters were prepared, using the DMT route of Example 1, containing different amounts of DHBP, THPA and APS treated nanosilica. Sheets were prepared from these compositions. The sheets were irradiated at various doses using the Fusion VPS/I600 equipment. The temperature of the sheet surface after the first pass was 75° C. and 85° C. after the second and subsequent passes. The gel content of the irradiated sheets was measured, and the results set forth in Table 8.

TABLE 8

| | | | APS- | | | | | |
|---|---|---|---|---|---|---|---|---|
| | DHBP | THPA | SiO₂ | Dose, J · cm⁻² | | | | |
| Run | wt. % | wt. % | wt. % | 20 | 40 | 80 | 120 | 160 |
| 24 | 4 | 8 | 0 | 85% | 86% | 94% | 100% | 100% |
| 25 | 4 | 10 | 0 | 78% | 88% | 100% | 100% | 100% |
| 26 | 1.5 | 4 | 0 | 24% | 52% | 70% | 94% | 97% |
| 27 | 1.5 | 4 | 2 | 39% | 54% | 93% | 98% | 98% |
| 28 | 4 | 8 | 2 | 48% | 63% | 95% | 95% | 100% |

### Example 6

A copolyester was prepared using the procedure described in the Experimental section that contained 4 wt. % DHBP and 8 wt. % THPA. Sheets were prepared from this composition compounded with various amounts of HP3786 glass fibers, nanosilica and APS treated nanosilica. These sheets were irradiated at various doses using the Fusion VPS/I600 equipment at various belt speeds by passing the sheet passed the lamps in one direction, turning the sheet over and passing the sheet back though the lamps. The temperature of the sheet surface after the first pass was 75° C. and 85° C. after the second and subsequent passes. The thickness of the sheets was 0.57±0.15 mm. The Failure Temperature was measured on sections of these irradiated sheets. The results are set forth in Table 9, the additive % are weight based on the copolyester.

TABLE 9

| | Glass, | SiO2, | APS-SiO2, | Dose, | Failure |
|---|---|---|---|---|---|
| Run | % | % | % | J · cm⁻² | Temp., ° C. |
| 29 | 0 | 0 | 0 | 160 | 152.9 |
| 30 | 0 | 0 | 0 | 300 | 165.2 |
| 31 | 0 | 0 | 0 | 340 | 167.4 |
| 32 | 15 | 0 | 0 | 160 | 157.4 |
| 33 | 15 | 0 | 0 | 300 | 168.3 |
| 34 | 15 | 0 | 0 | 340 | 162.9 |
| 35 | 20 | 0 | 0 | 340 | 276.4 |
| 36 | 30 | 0 | 0 | 160 | 272.8 |
| 37 | 30 | 0 | 0 | 300 | 277.3 |
| 38 | 30 | 0 | 0 | 340 | 277.8 |
| 39 | 0 | 2 | 0 | 160 | 168.3 |
| 40 | 0 | 2 | 0 | 300 | 176.3 |
| 41 | 0 | 2 | 0 | 340 | 170.3 |
| 42 | 15 | 2 | 0 | 160 | 172.3 |
| 43 | 15 | 2 | 0 | 300 | 272.3 |
| 44 | 15 | 2 | 0 | 340 | 275.5 |
| 45 | 20 | 2 | 0 | 340 | 275.9 |
| 46 | 30 | 2 | 0 | 160 | 273.7 |
| 47 | 30 | 2 | 0 | 300 | 274.2 |
| 48 | 30 | 2 | 0 | 340 | 278.6 |
| 49 | 0 | 0 | 2 | 160 | 158.8 |
| 50 | 0 | 0 | 2 | 240 | 159.6 |
| 51 | 0 | 0 | 2 | 300 | 190.2 |
| 52 | 0 | 0 | 2 | 340 | 269.5 |
| 53 | 15 | 0 | 2 | 160 | 274.6 |
| 54 | 15 | 0 | 2 | 240 | 273.7 |

At a UV dose of 300 J·cm⁻² or higher, sheets containing 20 wt. %, or higher, glass fibers exhibited a Failure Temperature of greater than 270° C. Similarly, at this dose, a mixture of 2 wt. % nanosilica and 15 wt. % glass fibers also achieved a Failure temperature of greater than 270° C. At a dose of 340 J·cm², the APS surface treated nanosilica exhibited a Failure Temperature of 269.5° C., which increased with the addition of glass fibers.

### Example 7

Trays were molded using two of the sheets prepared for Example 6 (copolyester containing 4 wt. % DHBP and 8 wt. % THPA), one without no additives and the other with 15 wt. % (based on the copolyester) HP 3786 glass fiber. The thickness of the sidewalls of the tray was 0.35 mm and the thickness of the bottom of the tray was 0.20 mm. The dose for each pass through the Fusion VPS/I600 equipment was 14 J·cm⁻² on the bottom of the tray. The temperature of the bottom of the tray surface after the first pass was 75° C. and 85° C. after the second and subsequent passes. The Failure Temperature was measured on the bottom of these irradiated trays, as well as a commercial CPET tray as a control. The results are set forth in Table 10.

TABLE 10

| Run | Glass, % | Dose, J · cm⁻² | Failure Temp., ° C. |
|---|---|---|---|
| 55 | 0 | 40 | 134 |
| 56 | 15 | 100 | 280 |

| | |
|---|---|
| CPET tray | 267 |

The tray from run #56 was filled with half cooked rice and placed in a convention oven at 280° C. for 15 min. On removal, the tray showed minimum distortion and was stiff enough to remove from the oven. A similar trial with the commercial CPET tray deformed after 5 min. and the tray buckled when removed from the oven.

### Example 8

Sheets from Example 6, without any reinforcing additives was biaxially stretched 4×4 at 200° C. The film was annealed under restraint at 185° C. for 4 hours. The film was UV irradiated at 150° C. with a dose of 150 and 300 J cm⁻¹. The tan δ of the film was measured and compared to the un-annealed and annealed film. The results are set forth in Table 11.

TABLE 11

| | Tan δ | Temperature of tan δ peak, ° C. |
|---|---|---|
| Un-annealed | 0.57 | 85.5 |
| Annealed | 0.17 | 97.1 |
| Annealed, 150 J cm⁻¹ | 0.25 | 109.8 |
| Annealed, 300 J cm⁻¹ | 0.18 | 119.7 |

The UV irradiation increased the tan δ peak temperature indicating a higher dimensional stability.

While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

What is claimed is:

1. A composition comprising a polyester, a photoreactive comonomer and a co-reactant, wherein said co-reactant comprises at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof.

2. The composition of claim 1 wherein said co-reactant is present in an amount of from about 0.1% to about 10% by weight of said composition.

3. The composition of claim 1 wherein said unsaturated anhydride is maleic anhydride or tetrahydrophthalic anhydride.

4. The composition of claim 1 wherein said photoreactive comonomer comprises at least one member selected from the group consisting of a diol of benzophenone, a dicarboxylic acid of benzophenone, a dicarboxylic ester of benzophenone, an anhydride of benzophenone and mixtures thereof.

5. The composition of claim 4 wherein said photoreactive comonomer is selected from the group consisting of 4,4′-benzophenone dicarboxylic acid, 3,5-benzophenone dicarboxylic acid, 2-4-benzophenone dicarboxylic acids, 4,4′-benzophenone dicarboxylic ester, 3,5-benzophenone dicarboxylic ester, 2,4-benzophenone dicarboxylic ester, 4,4′-benzophenone diol, 3,5-benzophenone diol and 2,4-benzophenone diols.

6. The composition of claim 5 wherein said photoreactive comonomer is 4,4′-dihydroxy benzophenone.

7. The composition of claim 1 wherein said photoreactive comonomer is present in an amount of from about 0.1% to about 10% by weight of said composition.

8. The composition of claim 1 wherein said polyester comprises at least one member selected from the group consisting of polyethylene terephthalate, polyethylene naphthalate, polyethylene isophthalate, polybutylene terephthalate, copolymers of polyethylene terephthalate, copolymers of polyethylene naphthalate, copolymers of polyethylene isophthalate, copolymers of polybutylene terephthalate, and mixtures thereof.

9. The composition of claim 8 wherein said polyester is a copolymer of polyethylene terephthalate.

10. The composition of claim 1 further comprising a filler.

11. The composition of claim 10 wherein said filler comprises at least one member selected from the group consisting of glass fiber, carbon fiber, aramid fiber, potassium titanate fiber, clay, mica, talc, graphite, a glass sphere, quartz powder, kaolin, boron nitride, calcium carbonate, barium sulfate, silicate, silicon nitride, titanium dioxide, oxide of magnesium, oxide of aluminum, nanoparticles selected from the group of silica, titanium dioxide and surface treated nanoparticles, and mixtures thereof.

12. The composition of claim 11 wherein said filler is glass fiber, nanosilica, surface treated nanosilica or mixtures thereof.

13. The composition of claim 10 wherein said filler is present in an amount of from about 0.1% to about 50% by weight of said composition.

14. The composition of claim 1 further comprising an additive.

15. The composition of claim 13 wherein said additive comprises at least one member selected from the group consisting of dye, pigment, filler, branching agent, anti-blocking agent, antioxidant, anti-static agent, biocide, blowing agent, coupling agent, flame retardant, heat stabilizer, impact modifier, ultraviolet light stabilizer, visible light stabilizer, crystallization aid, lubricant, plasticizer, processing aid, acetaldehyde, oxygen scavenger, barrier polymer, slip agent, and mixtures thereof.

16. The composition of claim 15 wherein said impact modifier comprises an ethylene acrylic copolymer or an ethylene acrylic methacrylic terpolymer.

17. An article comprising a polyester, a photoreactive comonomer and a co-reactant, wherein said co-reactant comprises at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof.

18. The article of claim 16 wherein the article is selected from the group consisting of a film, a sheet, a thermoformed tray, a blow molded container and a fiber.

19. The article of claim 16 wherein said article is UV cured.

20. The article of claim 19 wherein the temperature of said article during said UV curing is greater than about 75° C.

21. The article of claim 20 wherein the dose of said UV curing is about 10 to about 500 J·cm⁻².

22. The article of claim 19 wherein said article has a Failure Temperature of about 280° C. or greater.

23. A method for producing a polyester article comprising:
a) copolymerizing
i) an alkane diol or cycloalkane diol;
ii) an aliphatic dicarboxylic acid, a cycloaliphatic dicarboxylic acid or an aromatic dicarboxylic acid;
iii) a photoreactive comonomer comprising at least one member selected from the group consisting of a diol of benzophenone, a dicarboxylic acid of benzophenone, a dicarboxylic ester of benzophenone, an anhydride of benzophenone and mixtures thereof; and
iv) a co-reactant comprising at least one member selected from the group consisting of an unsaturated diol, an unsaturated aliphatic diacid, an unsaturated aromatic diacid, an unsaturated aliphatic ester, an unsaturated aromatic ester, an unsaturated anhydride and mixtures thereof
to form a polyester;
b) optionally compounding at least one member selected from the group consisting of a filler, an additive and mixtures thereof with said copolymerized polyester;
c) molding said article from said polyester, and
d) UV curing said article.

24. The method of claim 21 wherein said article has a Failure Temperature of about 280° C. or greater.

25. The method of claim 21 wherein the said molding step (c) and UV curing step (d) are integrated into a continuous process.

26. The method of claim 21 wherein the said UV curing uses UV-A radiation and a 325 nm cut-off filter.

27. The method of claim 26 wherein the dose of said UV-A radiation is about 10 to about 500 J·cm⁻².
